(19) United States
(12) Patent Application Publication
(10) Pub. No.: US 2014/0351184 A1
(43) Pub. Date: Nov. 27, 2014

(54) USER SPECIFIC PLAN GENERATION METHOD AND SYSTEM

(71) Applicants: Plaban Kumar Bhowmick, Kolkata (IN); Debnath Mukherjee, Kolkata (IN); Prateep Misra, Kolkata (IN)

(72) Inventors: Plaban Kumar Bhowmick, Kolkata (IN); Debnath Mukherjee, Kolkata (IN); Prateep Misra, Kolkata (IN)

(73) Assignee: TATA CONSULTANCY SERVICES LIMITED, Mumbai (IN)

(21) Appl. No.: 14/365,093

(22) PCT Filed: Dec. 10, 2012
(86) PCT No.: PCT/IN2012/000807

§ 371 Date: Jun. 12, 2014

(30) Foreign Application Priority Data
Dec. 13, 2011 (IN) 3502/MUM/2011

(51) Int. Cl. G06N 5/02; G06N 99/00; G06Q 50/00

(52) U.S. Cl. CPC G06N 5/02; G06Q 50/01; G06N 99/005
USPC 706/12; 706/46; 706/51; 706/55

(57) ABSTRACT

The present invention envisages a personalized plan generation system and a method that satisfies maximum user preferences and constraints; besides including a number of enabling features like of plan repair or revision with dynamically changing situations or contextual information. Moreover, the system is able to perform a collaborative planning by opinion mining in social networks to achieve better optimization. Significantly, the explanation for the selection of plan steps or a change in plan altogether can be expressed in natural language.

### FIELD OF THE INVENTION

The present invention generally relates to the field of planning and, more particularly, to an optimal planning system and method that is capable of generating personalized plans, specific to the user.

### BACKGROUND OF THE INVENTION

Hierarchical Task Network (HTN) based planners belong to the domain configurable planning paradigm where the core planning method is domain independent; however, it can be crafted for a specific domain by supplying domain relevant control knowledge. As these planners can generate instant efficient plans, they are widely used in practical applications. These planners being smart and more expressive provide a useful way to derive desirable solutions, specific to a domain. However, the observable disadvantage with these planners is their inability to handle preferences and constraints that can actually be defined over all the states of the plan trajectory. Further, these plans need revision based on changing situations, for say changing specified preferences and constraints.

One naïve way to revise plan is to replan from the initial state in response to each plan revision trigger, but limitations are many. Firstly, usually a part of the plan has already been executed and in most of the cases they cannot be undone. One solution to this limitation is to start re-planning from the current execution state. This strategy may not be optimal and may not be a good strategy for operations in real time. It is therefore needed to find the optimal state after the current state from which the re-planning can be done. No HTN planner is known to perform the plan revision in an optimal way so far.

Sometimes the explanation behind the selection of plan steps in human readable form is helpful to the users. However, none of the existing planners provide any natural language explanations behind the selection of plan steps that can actually help a user attaining requisite comfort with the proposed plan.

The HTN planners represent the goal tasks, initial state and domain facts through task description and the control knowledge is expressed in domain description. The description of the tasks and planning domains are currently represented by some languages that are hard to understand by the application developers.

Other notable limitation with the existing planners is that the plans generated for different users are generic in nature, not specifically fulfilling individual user's demand and preferences. Further, these generic plans selected for a user may be influenced by the opinions of the other user regarding the entities involved in the plan step. This generates the need for addressing the criticality of collaborative planning feature, which has not been realized by any of the existing planners so far.

All the more, the advances made in the domain of automated planners has been limiting with respect to their field of use. None of the planners has been able to provide a generic planning system that is capable of planning for varied domains, at the same time behaving specific in their genericity by generating personalized plans.

U.S. Pat. No. 7,895,065 discloses a method and apparatus for providing an itinerary planner that generates itineraries for visiting locations which are personalized to the user's preferences. However, it is merely an itinerary planner that handles unknown contingency conditions and restricted for tours and traveling for visiting locations. The system disclosed in the art, is not a generic planning system that can be adopted for all multiple domains and neither does it addresses the issue of dynamic optimization under varying user preferences, intent and contextual information.

In the light of foregoing, there exists a need for a planner that can overcome all the above discussed limitations and provide a common solution that is more efficient, specific and optimal under changing plan execution environment.

### OBJECTIVES OF THE INVENTION

The principle object of the present invention is to provide a system and a method of generating high quality personalized plans satisfying all constraints (valid plans) and maximum number of preferences (optimal plan) defined over all the states in the plan trajectory.

Another object of the present invention is to develop a domain and application specific plan generating system to solve user specific tasks.

Another significant object of the invention is to generate an optimal personalized plan considering all observable variables like time, money, manpower etc.

It is another object of the present invention to provide a personalized plan generating system capable of detecting dynamically changing contextual information and situation such that the system triggers a revision in the currently executing plan and generates an optimized alternative plan.

One of the other objects of the present invention is to present a personalized plan generating system that is capable of providing an optimized alternative plan whenever a user personally request for the same.

Another object of the invention is to enable the personalized plan generating system for generating logical coherent explanations behind selection of planning steps in natural language.

Yet another object of the invention is to enable the personalized plan generating system to perform collaborative planning by opinion mining in social networks, blogs and social media such that the generated plan achieves considerable optimization levels.

### SUMMARY OF THE INVENTION

Before the present methods, systems, and hardware enablement are described, it is to be understood that this invention is not limited to the particular systems, and methodologies described, as there can be multiple possible embodiments of the present invention which are not expressly illustrated in the present disclosures. It is also to be understood that the terminology used in the description is for the purpose of describing the particular versions or embodiments only, and is not intended to limit the scope of the present invention which will be limited only by the appended claims.

The present invention envisages a system and method of generating highly optimized user specific plan by integrating the planning server and the user preference modeling system such that the system considers all constraints and maximum number of preferences of the user; identify plan revision conditions with varying user preferences, constraints, contextual information or other relevant information and accordingly revise the currently executing plan to adapt to the changed situation or prepare an alternative optimized plan; generate logical explanation for selecting different plan steps and alternate plan in a natural language; and collaborate with social networking platforms for seeking opinion of other entities to achieve destined optimization levels.

In the preferred embodiment of the invention a computer implemented method of generating an optimal personalized plan is provided, wherein the said method is executed on a planning server that is communicatively coupled to a user preference modeling system on a communicating network. The method for realizing the said invention comprises of the following steps:

a) receiving by a server computing system, at least one user defined task and associated subtasks; b) extracting dynamic context information and a plurality of control points relevant to the task wherein, each of the control point indicates an optimal state; c) generating a primary optimal plan complying with the said task, the context information and each of the control point, the plan constituted of a plurality of intermediate states to achieve a goal state; and d) iteratively performing a backtracking operation from the goal state to the currently executing intermediate state to identify a deviating intermediate state from the optimal state for ensuing generation of a secondary optimal plan from the identified deviated intermediate state.

One of the other preferred embodiments of the present invention discloses a computer implemented method of generating an optimal personalized plan on a planning server integrated with a user preference modeling system on a communicating network and communicatively linked to a social platform for collaborative planning, wherein the said method comprises of the following steps: a) receiving by a server computing system, at least one user defined task and associated subtasks; b) extracting dynamic context information and a plurality of control points relevant to the task and the context information, each of the control point indicates an optimal state; c) generating a primary optimal plan state complying with the said task, the context information and each of the control point, the plan constituted of a plurality of intermediate states to achieve a goal state; d) determining a next plan state by a process of opinion mining, said opinion mining further comprising: aggregating one or more opinion of multiple entities located at different sources or networks along with the subtasks contained in one or more category of the user preference modeling system, assigning an updated score to each of the aggregated opinion for prioritizing in accordance with a predetermined category score; and selecting the highest updated scored opinion thereof wherein the said updated scored opinion is derived by a combination of the entity opinion score and the category score; and e) iteratively performing a backtracking operation from the goal state to the currently executing intermediate state to identify a deviating intermediate state from the optimal state for ensuing generation of a secondary optimal plan state there from the deviated intermediate state.

Another preferred embodiment of the present invention presents an optimal personalized plan generation system implemented on a planning server, wherein the system further comprises of:

a user preference modeling system to model a user defined task and associated subtasks;

a context processing module communicating with a plurality of sensors and an ontology store management system for extracting dynamic contextual information; and

a plan execution decider module for generating a primary optimal plan in compliance to the task, the subtasks and the contextual information, wherein the decider module is configured to generate a secondary optimal plan upon an indication of deviation from the user preference modeling system or the context processing module plan or a combination thereof.

### BRIEF DESCRIPTION OF THE DRAWINGS

The foregoing summary, as well as the following detailed description of preferred embodiments, are better understood when read in conjunction with the appended drawings, wherein like elements are given like reference numerals. For the purpose of illustrating the invention, there is shown in the drawings example constructions of the invention; however, the invention is not limited to the specific methods and system disclosed. In the drawings:

FIG. 1 depicts a block diagram showing an overall view of the system in accordance with one of the preferred embodiments of the present invention.

FIG. 2 is a detailed representation of the components of the system in accordance with one of the disclosed embodiments of the present invention.

FIG. 3 shows the detailed components of the plan revision decider module, in accordance with a disclosed embodiment of the present invention.

FIG. 4 is an exemplary illustration of the components of the system as viewed by the application developer, according to an embodiment of the present invention.

FIG. 5 details the components of the opinion extraction module for collaborative planning, in accordance with one exemplary embodiments of the present invention.

FIG. 6 is a flow chart broadly representing steps involved in generating the optimal personalized plan, in accordance with a preferred embodiment of the present invention.

FIG. 7 is a flow chart showing steps involved during plan revision, in accordance with an embodiment of the present invention.

FIG. 8 is a flow chart for plan explanation generation system, in accordance with an embodiment of the present invention.

FIGS. 9(a & b) represents a flow chart for visitor request tour workflow, in accordance with a preferred embodiment of the present invention.

FIGS. 10(a & b) is a flow chart showing steps of visitor implementing the plan suggested by the system, in accordance with a preferred embodiment of the present invention.

FIG. 11 is a flow chart representing steps followed when a visitor cannot find the attraction and requests to consult alternative sources of information, in accordance with one of the preferred embodiments of the present invention.

FIG. 12 is a flow cart representing steps followed during execution of an alternative plan whenever a user personally requests for the same, in accordance with one of the preferred embodiments of the present invention.

FIG. 13 is a flow chart representing steps that are invoked whenever a change in contextual information is detected, in accordance with one of the preferred embodiments of the present invention.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred systems and methods are now described.

The disclosed embodiments are merely exemplary of the invention, which may be embodied in various forms. Software programming code, which embodies aspects of the present invention, is typically maintained in a permanent storage such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communication network, such as the Internet. In addition, while the invention may be embodied in computer software, the functions necessary to implement the invention may alternatively be embodied in part or in whole using hardware components such as application-specific integrated circuits or other hardware, or some combination of hardware components and software. Input/output or I/O devices (including but not limited to keyboards, displays, pointing devices, etc.) can be coupled to the system either directly or through intervening I/O controllers. Further, a computerized method refers to a method whose steps are performed by a computing system containing a suitable combination of one or more processors, memory means and storage means.

The proposed planning system of the present invention is implemented on a plurality of loosely coupled different servers and computing devices that are capable of generating high quality plans that satisfies all the domain posited constraints and maximum numbers of preferences specified by the users. The other advantageous feature of the invention is its capability to generate highly optimized context aware plans with respect to changing contextual information and other varying variables like time, money, manpower etc. Further, the system is capable of detecting change(s) in situation and suggesting an optimized alternative plan or a revision in the present plan upon such detection in an optimal way. The system is, therefore, able to revise or repair the currently executing plan if it is perceived that the target state or what is here-on referred as the goal state cannot be achieved with the changed situation. Additionally, the system generate logically coherent explanations in natural language behind selection of different steps in the plan or a different plan altogether. Moreover, the system takes care of a situation whereby the selection of a plan step is influenced by the opinion of the other users about the entities involved in the plan step. This is achieved by way of collaboration with the social networking platforms for opinion mining.

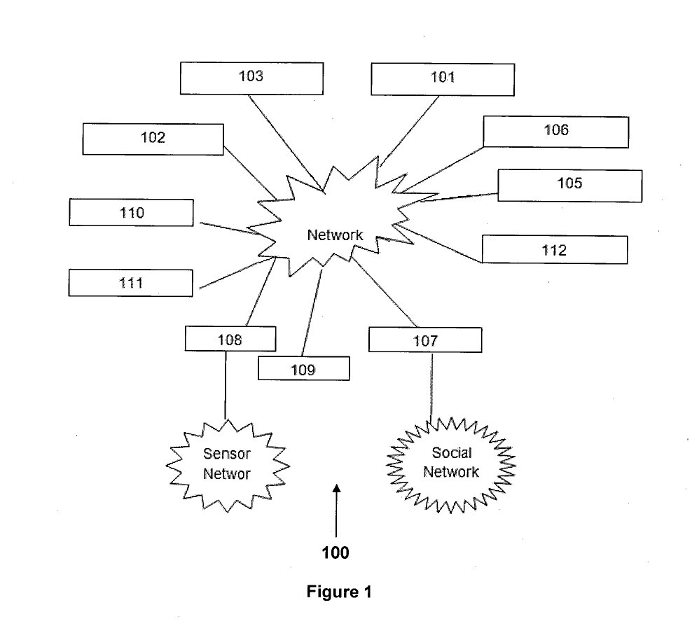

With reference now to FIG. 1, an exemplary block diagram of the system is provided in which illustrative embodiments of the proposed invention may be implemented. It should be appreciated that FIG. 1 is only exemplary and not intended to assert or imply any limitation with regard to the environments in which different embodiments may be implemented. Many modifications to the depicted environments may be made. The system 100 of FIG. 1 comprises of a communicating network of computer modules that are communicatively linked by a networking system like wires, wireless communication links or fiber optic cables. The network system here refers to the Internet representing a worldwide collection of networks and gateways that use the Transmission Control Protocol/Internet Protocol (TCP/IP) suite of protocols to communicate with one another. The internet enables high speed communication between the network computers and gets implemented either by intranet, a local area network (LAN), or a wide area network (WAN). Further, the users for the purposes of the present invention may be personal computers or network computers.

As mentioned earlier the proposed planning system 100 is loosely coupled having different sub-systems implemented in different hardware and software platforms. These subsets are connected to each other by a communication network. The proposed system 100 is a combination and coordination of different modules or entities like:

a) a user interface 101 that is configured to receive the inquiry from the user and activate the interactive features of the system 100. Upon receiving the issued task, the user interface 101 transmits the task related information to the task description generator module 103. This user input sub-system can be implemented via one webpage or standalone software running on a personal computer, servers or small display devices like mobile or tablet personal computer. The users can specify their intents and preferences through this interface.

b) Ontology store management system 102 (both domain and application ontology) which is a combination of an ontology database, ontology management tool and ontology extraction module.

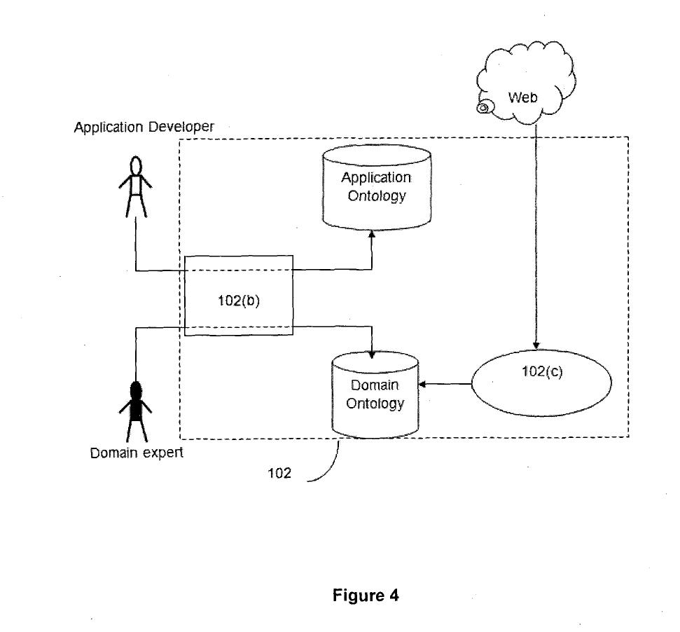

Further details of the system 102 are elaborated in FIG. 4.

c) Task description generator module 103 for generating description of task issued by the user. The module 103 consults the domain knowledge stored in ontology store management system 102 to extract relevant facts about their domain and these facts are inserted in the task descriptions as axioms.

d) Domain description generator module 104 that creates descriptions about the tasks and the actions. The domain description generator module along with the task description module can be collectively termed as the defining module.

e) Planning server 105 that is domain independent and uses HTN based planning paradigm for generating plan taking domain description and task description from modules 103 and 104 (or defining module) as inputs.

f) User preference modeling system 106 for providing implicit user preferences and intent to assist the system 100 in generating personalized plans. The system 106 can be realized through relational database systems and user modeling unit that has been elaborately defined in later sections of the specification.

g) Context processing module 107 that listens to the streaming sensor feeds relevant to the domain in concern and extracts higher level context for transmittance to the module 103 and plan revision decider module 109. The module 107 can be realized through stream processing systems which receive streaming data from sensors and generate events relevant to the application.

h) Plan execution monitor module 108 that monitors the user's activities relevant to the application to derive the state of the user in certain point of time.

i) Plan revision decider module 109 that takes the context stream and the world state as inputs from context processing module 107 and plan execution monitor module 108 respectively to identify if a plan revision condition exists or not. The plan revision decider module and the plan execution monitor module is further contained within a plan execution decider module (not shown in the Figure) that is responsible for generating a optimal plan in consonance with the user preferences, intent or contextual information.

j) Opinion aggregation module 110 for receiving the entities involved in collaborative planning process. The module interacts with various social networking platforms to which the user is connected, to generate aggregated opinion about those entities by performing opinion analysis over the social networks.

k) Plan explanation generator module 111 that generates logical coherent explanations in natural language for selecting the plan steps in a currently executing plan.

l) Plan rendering module 112 or a display interface that is configured to accept and generate the optimal plan along with the plan explanation on its interface. The module can be realized through webpage, standalone PC software running on Desktop PC, Tablet PC or mobile phones.

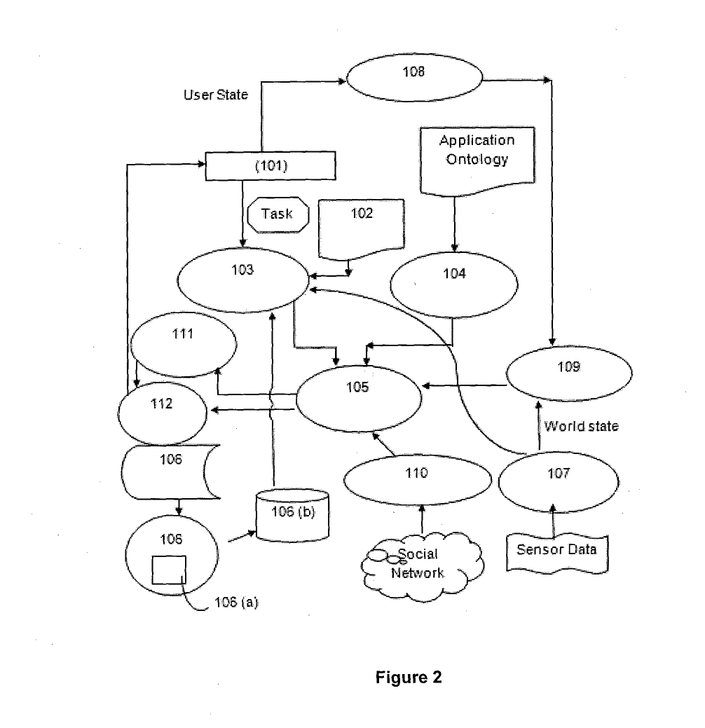

An elaborate diagram of the inter-connected components of the system 100 is shown in FIG. 2. The planning system 100 helps the user (or an application developer) to develop domain (or application specific) specific planners 105 to solve user specified tasks. The components of the system 100 are further expressed in two different views is shown in FIG. 4. Now referring specifically to FIG. 2, a user interface 101 is provided that is coupled to task description generator module 103 for transmitting the task(s) issued by the user to the module 103. The task description generator module 103 is further coupled with domain ontology to extract relevant facts about the domain for inserting these facts in the task descriptions as axioms. Along with the facts, the user specified tasks, preferences and domain imposed constraints is incorporated in the formal language. The task description generator module 103 also receives implicit user preferences learnt through user preference modeling system 106 and context specific constraints extracted through context processing module 107, as shown in FIG. 2.

On the other hand, the application ontology is connected to the domain description generator module 104 to create descriptions about the tasks and the activities. The system 100 of the present invention uses SHOP2 like HTN (Hierarchical Task Network) formalism for representing both domain and task descriptions (defined by a defining module) with relevant extensions for accommodating constraints and preferences. The domain description generator module 104 is further connected to the domain independent planning server 105 that uses HTN based planning paradigm for generating plans as it takes inputs from the defining module. The domain specific configuration is done with the domain description in module 104. The generated plan for a user specified task is a sequence of steps that if followed will achieve the goal task. Alternatively, the planner is also capable of considering other agents' view regarding the entities involved in the plan steps by aggregating opinions about the entities through social network mining in case of generating a collaborative plan.

The user preference modeling system 106 comprising of a relational database 106(a) integrated within the system 106 and a user modeling unit 106(b) for analyzing the plan execution history of a user to keep a track of his or her implicit preferences and sending them to the task description generator module 103. The user preference modeling system 106 analyzes and adopts the reinforcement based learning along with preference score update function for prioritizing the received user preferences.

The context processing module 107 listens to the streaming sensor feeds sensed by linked sensors 107(a) to extract higher level contextual information which gets forwarded to the task description generator module 103 and also to the plan revision decider module 109. The process of plan execution is repeatedly monitored by the plan execution monitor module 108 to derive the state of the user or an executing agent in certain point of time and therefore remains connected to the user interface 101.

The plan revision decider module 109 is communicatively coupled with a plan execution monitor module 108 (both collectively contained within a plan execution decider module) to determine the user state and context processing module 107 to receive the changing contextual information in order to identify whether a plan revision condition exists or not. There are three different scenarios in which plan revision situation may exist:
a) The user manually requests for a plan revision;
b) The user has taken a course different than that specified in the plan;
c) There is a change in context that poses threat to the achievement of the goal task; or
d) The user changes the preferences and intents during run time.

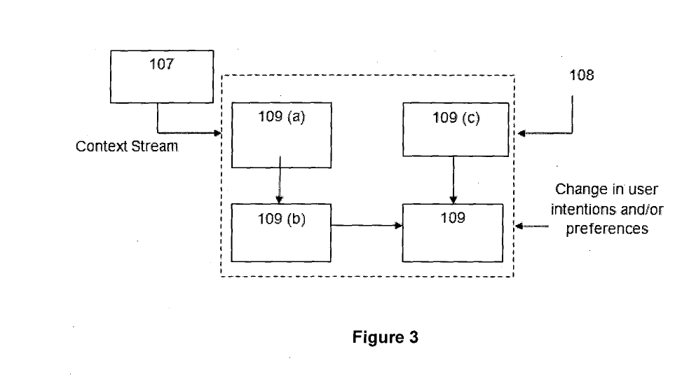

The components related to the plan revision decider module 109 are elaborately discussed in FIG. 3 wherein the context change detector component 109(a) detects the change in ever varying context stream, so sensed by the context processing module 107. In this process, it continuously listens to the context stream generated by the module 107. Storing this continuously incoming streaming data and performing reasoning over it may not be feasible for applications that require real time response. To overcome this situation, the module 107 is implemented with belief revision or truth maintenance based technique coupled with streaming reasoning techniques. Any change in context will generate a trigger that acts as an input to the goal threat detector component 109(b) of the plan revision decider module 109. The goal threat detector component 109(b) probe the plan trajectory from current state to goal state of the currently executing plan to detect whether a goal can still be achieved. If not then this module will generate a plan revision trigger for plan revision decider module 109. The plan deviation detector component 109(c) works in collaboration with the plan execution monitor 108 to probe whether there is a deviation from the scheduled plan. The plan revision module of the plan execution decider module is implemented through goal task regression strategy by backtracking from the goal state in HTN network. The backtracking is stopped as soon as the current state is reached without any threat to goal and it starts re-planning from the current sate; otherwise, backtracking is halted at the state which shows the possibilities of violating the goal conditions and re-planning is done from this state. This strategy ensures the optimality of plan revision with respect to the number of steps needed to be revised.

As mentioned above, the components of the system 100 from applications developer's point of view is presented in FIG. 4. The system 100 generates task and domain descriptions related to planning from application and domain ontology, each represented as ontology store management system 102. The application ontology store—a database 102(a) stores the application specific knowledge like: tasks related to the application; dependencies among the issued tasks; conditions for invoking a task; different constraints governing the tasks and so on. The application developer makes use of an off-the-shelf ontology management tool 102(b) to create the application ontologies, manage and store them in application ontology stores 102(a). Similarly the domain experts also uses ontology management tool 102(b) to create domain ontologies. Apart from the manual entry of domain ontology, the ontology store management system 102 is able to extract parts of domain ontology from structured web data e.g. Wikipedia, dbpedia and different application related web pages using ontology extraction module 102(c).

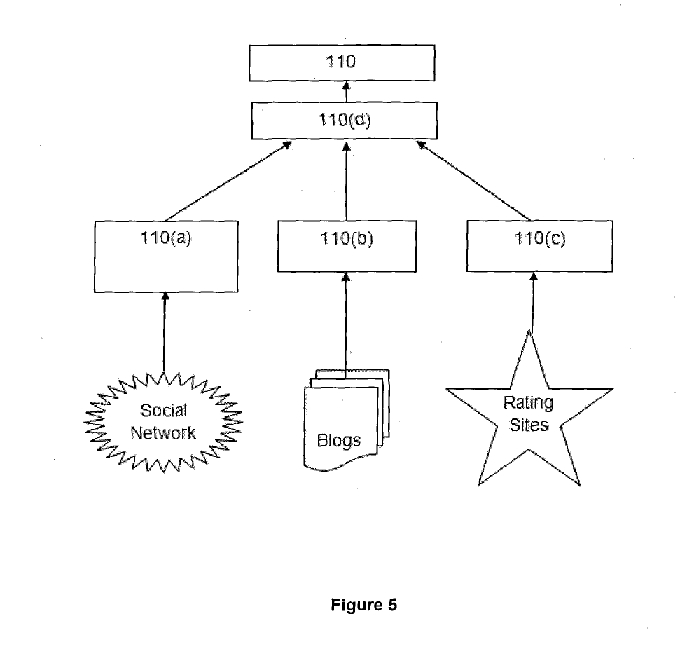

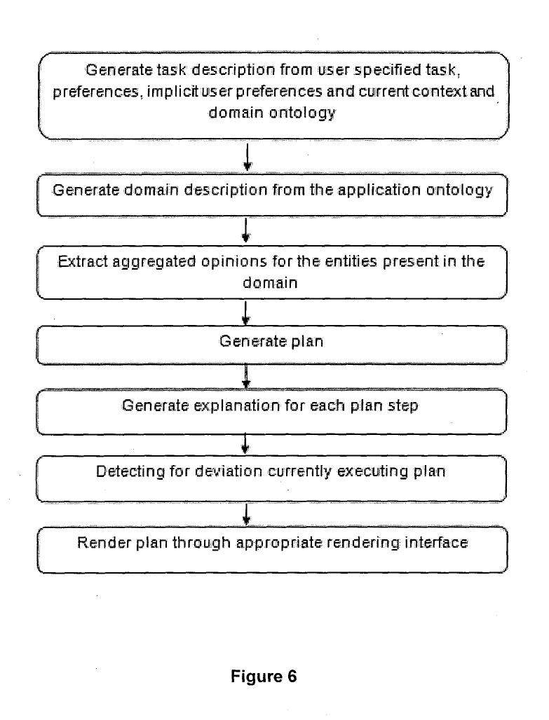

FIG. 5 demonstrates the extended components of the system 100 while the system performs collaborative planning by opinion mining in social networks. Sometimes the selection of a plan step may depend on the opinion of other users on the entities present in the plan step. The opinions can be extracted from different social networks that the user is connected to and other sources like blogs or rating sites. The proposed planner takes into account others opinion published in different sources about the entities to decide about the inclusion of a step in the current plan. Now referring to FIG. 6, three different sources for aggregating opinions of the others regarding the entities involved in a future planning step: social networks, blogs and rating sites is shown. However, these sources are only listed for illustrative purposes and in no way mean to limit the invention.

For social networks and blogs, text analytics based topic opinion extraction methodologies are used by the social network opinion extractor 110(a) and blog opinion extractor 110(b) for extracting the associated opinions thereof respectively. These opinion extractors can be implemented in cloud resources and servers. Rating aggregation techniques are used to extract opinion about entities for ratings published in different sites about the entity by the rating opinion extractor 110(c). The score aggregator module 110(d) normalizes the scores from different sources and finally performs weighted aggregation to compute the final scores for positive or negative opinion and forward it to the opinion aggregation module 110. The entity is assigned with positive opinion or negative opinion whichever has got the score greater than some threshold; otherwise it is assigned with neutral opinion.

Next. FIGS. 6(a & b) presents the flowchart of the steps involved in the proposed planning system. As discussed, the user interface 101 receives user specified tasks and preferences from the user. Implicit user preferences from the user preference modeling system 106; contextual information from context processing module 107 and domain ontology maintained in the ontology store management system 102. Following the reception of inputs from various modules, description of the received tasks is generated by the task description generator module 103 along with the domain description from the application ontology by domain description generator module 104. To overcome the difficulty in task and domain description, the proposed system makes use of ontology store management system 102 that is integrated to the application developer interfaces where the application developers and the domain experts will be developing application and domain ontologies. The system 102 will be then able to generate planning specific task and domain descriptions by querying the ontologies.

To enable the realization of present invention, it is disclosed that the invention proposes a language for expressing constraints and preferences that holds for all the intermediate states along with goal state in the plan trajectory. The domain relevant knowledge, preferences, constraints and intents of the user may be expressed through the language. A language parser parses that knowledge and generates planning state space using an intermediate representation. The domain independent planner 105 then applies some meta-heuristics based optimization approach over this internal representation to generate optimized plans. The proposed system represents the user preferences through user module 106(b) of the user preference modeling system 106 and maintains them in the relational database 106(a) by analyzing the plan history of the respective users. The user model 106(b) adopts reinforcement based learning along with the preference score update function for prioritizing the preferences. The constructed user models are then used in plan generation process for generating personalized plans.

In case, the system 100 intends to incorporate opinion and views of the multiple entities for generating a collaborative plan, an aggregated opinion from disparately located multiple entities that are present in the domain, is extracted. The next available plan steps are prioritized with opinion scores of the entities involved in the individual plan steps. The step with highest priority is selected as the next plan step. To obtain the opinion score of each entity, opinion mining in different sources like social networks, social media and blogs is performed. Thereon after the consideration of the opinion or otherwise, a plan is generated along with a logical coherent explanation for each plan step.

Further, the user model 106(b) for the purposes of personalized planning categorizes the user preferences and intent along with their properties in a set of categories contained therein. For example, hotel, restaurants, transport are the categories. Hotel may have properties like has_rating, has_restaurant, has_banquet_hall etc. As this information is stored in the domain ontology, user model for one application may be realized through a part of the domain ontology. However, the entities in the user model ontology have associated scores reflecting the user's inclination towards those entities. These scores are initiated with some default value or can be acquired through some static user profiling technique. The scores attached to the categories are updated after execution of one plan.

The scores are updated with the following formula:

w′+w+Δ

where w is the previous score, w′ is the updated score and Δ is the reward value which may be positive or negative.

The category scores are updated based on the following conditions.
The category score will be updated with a positive reward (Δ) if it is present in the user specified initial and runtime preferences.
The plan is accepted by the user and executed without any failure. All the entities involved in the plan will receive a positive reward (Δ) value. The entities are then mapped to categories and the concerned category will receive the updated value.
The user asks for a plan revision and edits the plan by eliminating some plan steps. In this case the categories related to the entities involved in the eliminated plan steps will receive a negative Δ value.

For example, the developed user model is useful in following scenarios.
The user has mentioned that he/she will be visiting a city and like to have a plan without specifying his intentions and preferences. The system will then consult the user model and consider intentions and preferences with higher scores while creating a plan.
The user has specified some intentions and preferences and duration for plan execution. It may so happen that the plan execution time is less than the specified duration. In this case, the user will be suggested some other steps by consulting the user model.
The user specified goals or intentions and preferences may not be accommodated within the user specified duration. In this case, the system will exclude the items having lower scores in user model.

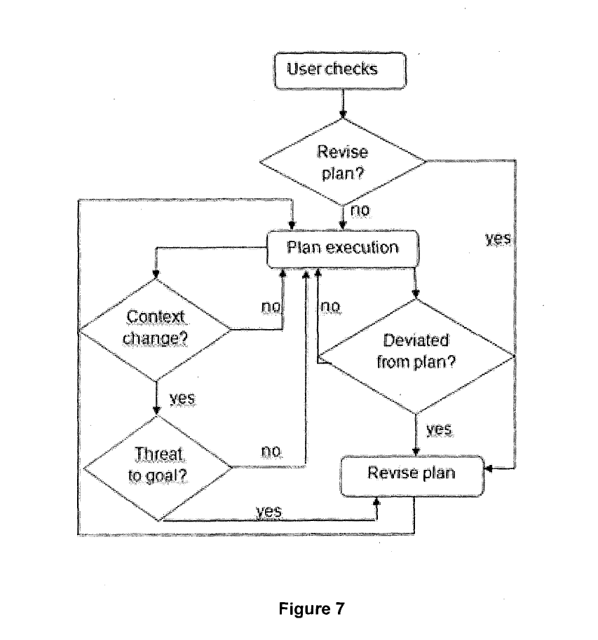

Next, the most significant step that contributes towards the generation of an adaptive optimized plan is the ability of the system to revise or repair the currently executing plan if it is perceived that the goal state cannot be achieved with the changed situation using the plan revision decider module 109. To detect plan revision, the proposed system 100 employs belief revision or truth maintenance based technique. The flow chart for steps involved in plan revision are discussed in FIG. 7 wherein in order to find optimal plan revision point (state), the module 109 will judge whether a change in situation deviates the plan from the control points defined for each of the intermediate state. The change in situation can be either by changing user preferences or intent or dynamically varying contextual information. If the deviation is beyond the control points and the threat in achieving a goal state is posited, the module 109 may trigger a plan revision and will find the states following the current state that pose threat to achievement of the goal state by working in close coordination with plan execution monitor module 108. Further, the proposed system gathers relevant information related to each planning step during planning process and stores them in a formal representation scheme. The system then employs natural language generation technology to transform formal plan explanation to natural language explanation using plan explanation generator module 111. The plan generation and revision can be realized in servers or cloud resources.

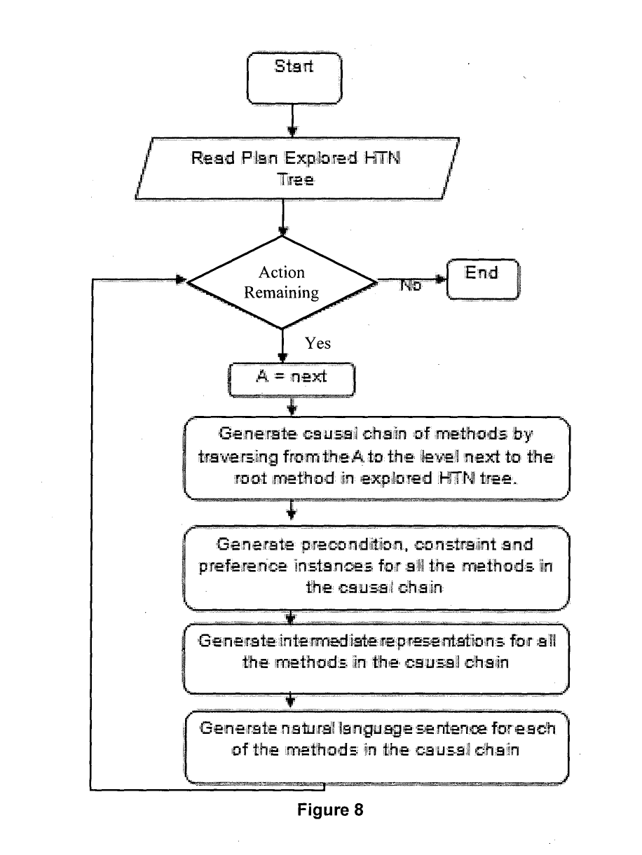

The plan explanation generator module 111 takes a plan and generates an explanation showing the reason for selecting the steps involved in the plan step. Plan is represented as a sequence of primitive actions. FIG. 8 presents the flowchart for generating plan explanations. The methods in the plan control knowledge specify how to decompose one task into different tasks, say subunits of tasks given a set of preconditions. Thus, starting from the initial task, all possible decomposition generates a tree (called HTN tree). However, during plan generation a part of the tree is explored, called as explored HTN tree. The primitive actions in the plan and the explored HTN tree are used to generate plan explanation. The actions in the plan are taken one by one.

For an action, causal chain of methods is generated by backtracking to the methods in the level next to the root node. For each method in the causal chain, the failure paths (those do not end up with primitive actions) are obtained. The failure paths may occur in situations like violation of constrains or preferences that does not meet optimization criteria. For successful methods, the preconditions are stored; whereas for unsuccessful methods the constraints violated and preferences not met are registered. Than each method in an intermediate representation is presented for using them to generate natural language sentences. The functional structures (f-structure) like Lexical Functional Grammar (LFG) can be used for this purpose. Rhetorical Structure Theory (RST) can be used to encode the relationships between the frames (methods). The natural language generator (NLG) then generates sentences using the frame structures and relationships among them. As the types of sentences that are required to be generated are not of wide variety, simple NLG systems will suffice for this task.

The output so generated by the planning system 100 is a sequence of steps that may be executed through the following primitive actions and are displayed by the rendering interface 112.

### BEST MODE/EXAMPLE OF WORKING OF THE INVENTION

The preceding description has been presented with reference to various embodiments of the invention. Persons skilled in the art and technology to which this invention pertains will appreciate that alterations and changes in the described structures and methods of operation can be practiced without meaningfully departing from the principle, spirit and scope of this invention.

An embodiment of the proposed planning system is explained herein for enabling the person skilled in the art to realize the invention without requiring any undue experimentation. The city tour and travel application is an embodiment of the proposed planning system. However, it should be noted that the proposed planning system is not limited to the mentioned travel and tour application. This particular embodiment discusses the development of a web portal for providing detailed plan for performing different activities regarding a city tour. This particular application falls in the gamut of smart city applications where it leverages the basic city infrastructure or related information to provide the end users (viz. travelers) with smart plans. The users, after logging in into the system, can specify their intentions (sight seeing, having food, entertainment options etc.) and a list of preferences. In return, the system provides plans that help in achieving the user goals satisfying all or a subset of the user specified preferences. The application will have the following features.
Pre-Plan: Based on the user specified goals and preferences, the system can generate initial plan before the user starts executing it.
Re-Plan: There may be some cases where the generated Pre-Plan needs to be revised. This may be an interrupt driven process. Some representative situations where re-planning is needed are given below.
   Emergency situations like user not feeling well
   The user explicitly drops some plan steps in run-time
   Unprecedented situations like irrecoverable threat to achieve a plan step
   Unprecedented delay in executing a planning step may affect the execution of following planning steps.
Personalized Plan: The system will be able to generate plans considering the users' likes and dislikes.
What others say: The system will decide upon including a step based on the others' opinions about the items present in that step. For example, a visiting place may get higher preferential value provided others have preferred it.
Optimized Plan: The system will not only optimize the plan with respect to the number of user preferences that have been satisfied but also some other metrics parameterized with different plan related variables. For example, the plan needs to be optimized with respect to cost, time and distance.
Plan Explanation: The system will provide the explanations behind selecting the individual planning steps in natural language.
Interactive Planning: The system will present the generated plan to the user where he can accept, reorder or reject the planning steps.
Map based Rendering: The system will render the plan in a map based UI using Google 3D map technology.
Virtual Run: The system will use mash-up of different information sources related to the city map, points of interest, hotel, restaurants etc. and provide virtual run of the planned tour.
Contextual Information: The system will consider different contextual information like user location, time of year, weather, companionship, traffic situation etc.

Description:

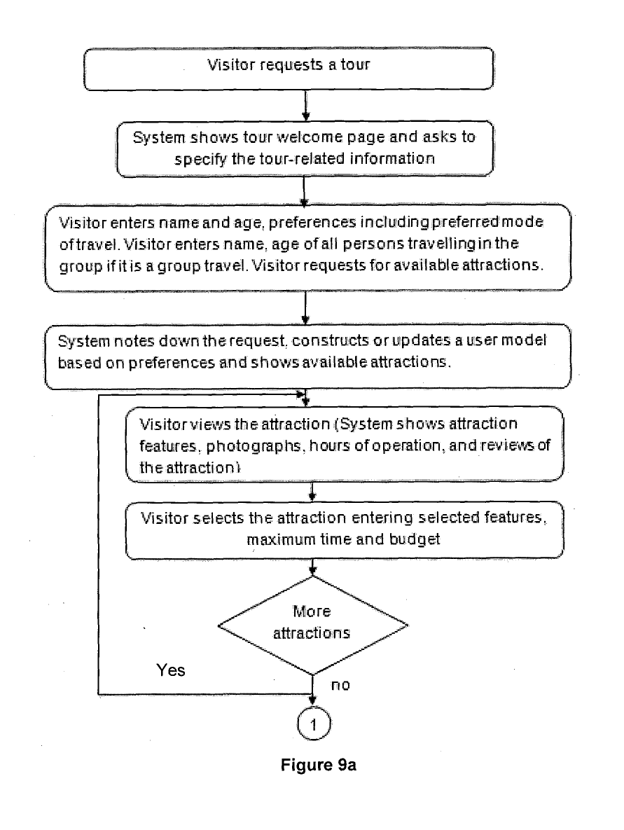

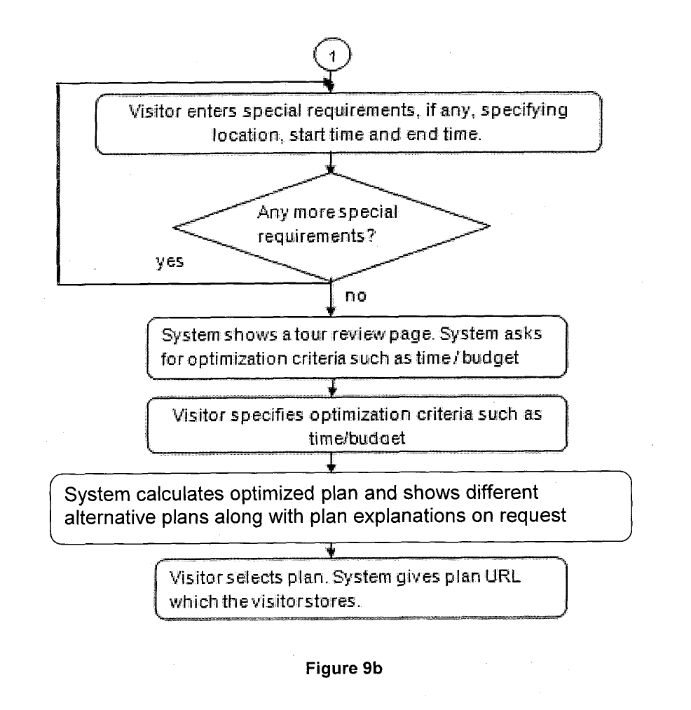

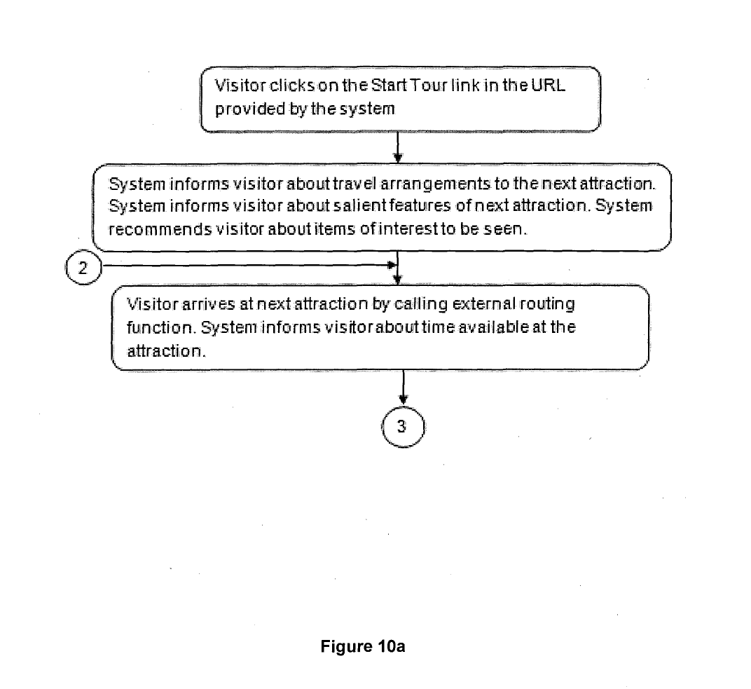

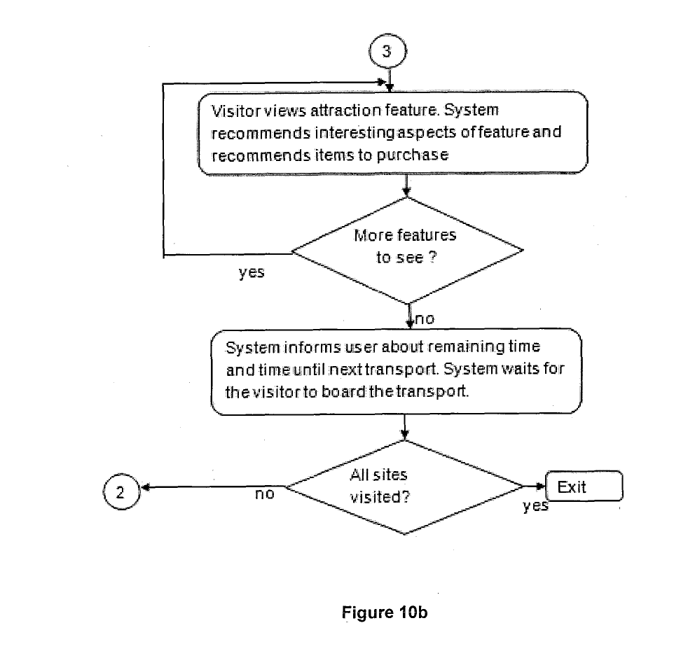

The visitor interacts with the system in two separate steps. Referring to FIGS. 9(a & b), in the “Visitor requests for tour” step, the system makes a plan for the visitor's tour based on the inputs from the visitor including his/her preferences. The system can take care of “special requirements” which essentially allows the visitor to attend to other engagements that he/she has (in addition to the city tour). To specify a special requirement, the visitor provides the time of the engagement and the location where he needs to be dropped off and picked up. The output of the “Visitor requests for tour” step is a URL that the visitor notes. In the “Visitor takes tour” step, the visitor is guided through the city tour as planned in the previous step. The user first click on the URL provided in the first step and then is taken through the tour. The elaborate flow diagram discussing how the “visitor takes tour” is shown in FIGS. 10(a & b). The user interacts with the system with the help of a mobile device such as a mobile phone.

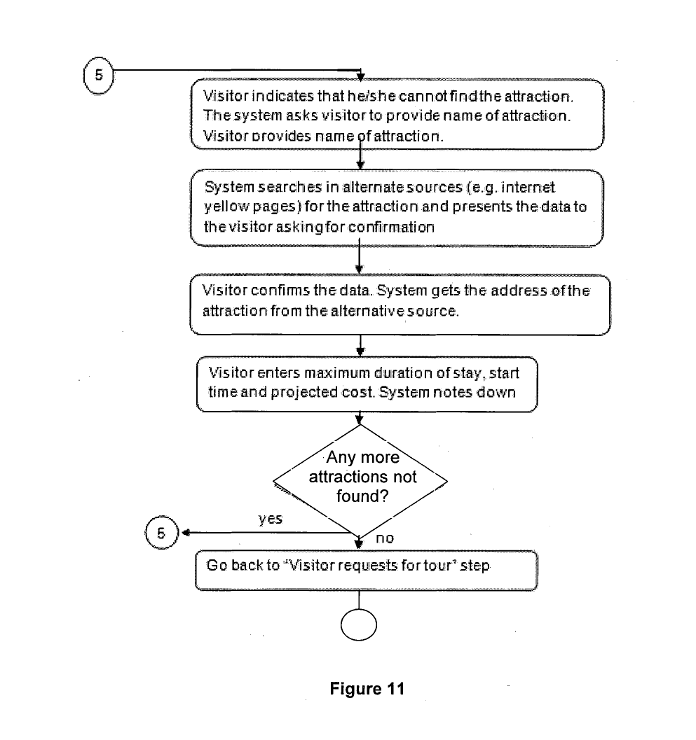

Referring to FIG. 11, a situation is presented when visitor cannot find the attraction in the list presented to him/her and requests system to consult additional sources. For example, here the visitor does not find his/her place of interest in the list of attractions maintained in the current database of the system. FIG. 11 briefs upon the steps undertaken in such a situation to ensure that visitor preferences and intent are duly taken care of. The system requires the visitor to submit the name of the attraction, following which the system searches for the inquiry and present before the visitor. If the visitor confirms, other relevant information is extracted and the plan gets generated.

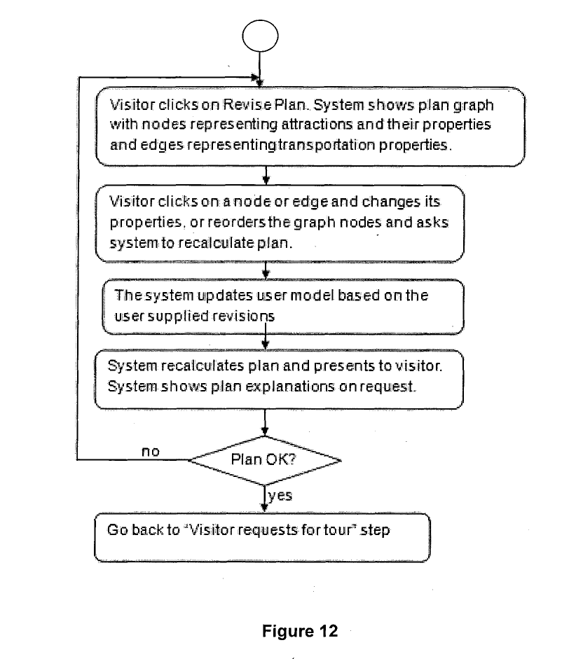

In one of the other embodiments, the visitor is shown to be unsatisfied with the current plan and needs a plan change. The alternative plan so generated when the “visitor requests for tour” is represented by a flow chart in FIG. 12. Here the system generates a directed graph with nodes representing the attractions which the user intends to visit and the edges represent the transportation properties to assist the visitor reach the specified attraction. The visitor is given the option to change the properties of the graph and ask the system for a new plan. These implicit preferences get stored in user preference modeling system and a new optimal personalized plan is generated after considering all the new intentions and preferences.

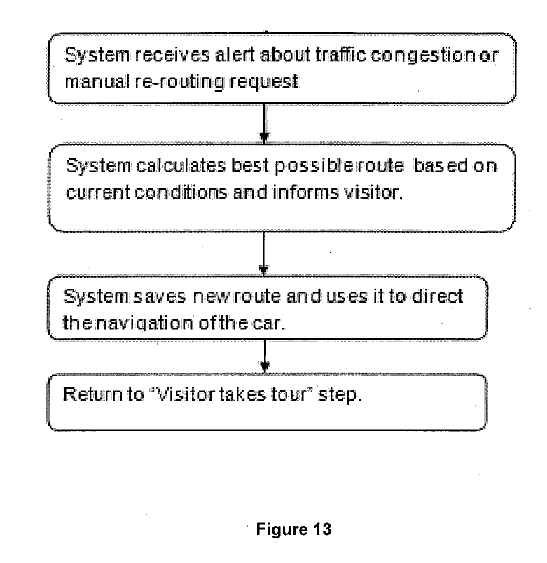

Now referring to FIG. 13, an alternative workflow fore situation like of manual revision request or any other change like the visitor has deviated from the pre-scheduled path and has followed or a different route or traffic congestion or a change in contextual information, is presented. Here the plan revision decider module 109 will check whether a re-routing is required or not. On re-routing request (either manual or automatic), the plan revision module 109 will include new routing request in the revised plan. The new routing step will call the external routing function to find the revised route to the destination from the current point.

The foregoing description of specific embodiments of the present invention has been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. The listing of steps within method claims do not imply any particular order to performing the steps, unless explicitly stated in the claim.

1. A computer-implemented method of generating an optimal personalized plan executed on a planning server in collaboration with a user preference modeling system over a communicating network, the method comprising:
receiving by a server computing system, at least one user-defined task and associated subtasks;
extracting dynamic context information and a plurality of control points relevant to the task wherein, each of the control points indicates an optimal state;
generating a primary optimal plan complying with the task, the context information each of the control points, the plan including a plurality of intermediate states to achieve a goal state; and
iteratively performing a backtracking operation from the goal state to the currently executing intermediate state to identify a deviating intermediate state from the optimal state for ensuing generation of a secondary optimal plan from the identified deviated intermediate state.

2. The method of claim 1, further comprising defining the received tasks, the associated subtasks and the extracted contextual information using stored domain information, the domain information being extracted from a plurality of dynamically maintained domain ontology.

3. The method of claim 1, further comprising rendering at least one optimal plan in compliance with the user-defined task and the associated subtasks, wherein the subtasks comprise at least one of one or more user preferences, intents, and constraints associated with the task.

4. The method of claim 1, further comprising:
rendering a logical explanation in a natural language for selecting at least one optimal plan by using functional structures (f-structures) of Lexical Functional Grammar to represent each intermediate state,
wherein the natural language sentences are formed by:
establishing relationships between the intermediate state constituting the plan by using a Rhetorical Structure Theory; and
utilizing the functional structures and the established relationships between the steps (f-structures) to generate the sentences by a Natural Language Generator.

5. The method of claim 1, wherein the planning server is a domain independent Hierarchical Task Network (HTN) planner that utilizes meta-heuristics based optimization approach to achieve the said optimization.

6. (canceled)

7. The method of claim 1, wherein the dynamic contextual information is extracted from the stored domain information, plurality of sensors, or a combination thereof.

8. The method of claim 1, wherein a belief revision or truth maintenance-based technique coupled with stream reasoning techniques are utilized to detect the change in contextual information.

9. The method of claim 1, wherein the defined task and the defined contextual information are represented on a SHOP-like HTN formalism with relevant extensions for accommodating the subtasks and the constraints.

10. The method of claim 1, wherein the backtracking operation from the goal state to the current state identifies for the changing contextual information positing a threat to the goal state such that the optimized secondary plan is generated from the deviated intermediate state identified of the threat.

11. The method of claim 1, wherein the deviated intermediate state from the optimal state in the currently executing plan network is detected for a change in one or more sub tasks or the user selection for a plan change or a combination thereof such that the optimized secondary plan is generated from the immediate intermediate state detected of such deviation.

12. The method of claim 3, wherein the rendered optimal plan is the primary plan for an undetected deviation of the intermediate state and the secondary plan for a detected deviation in the intermediate state, wherein each deviation creates a revised secondary plan.

13. The method of claim 4, wherein for the each plan state, the task is iteratively decomposed to form a relational tree and a semantic structured is derived based on a causal chain in the relational tree, traversed up to a level next to root node to generate a logical explanation of selecting the plan state in the natural language.

14. A computer-implemented method of generating an optimal personalized plan on a planning server in collaboration with a user preference modeling system over a communicating network and communicatively linked to a social platform, the method comprising:
receiving by a server computing system, at least one user-defined task and associated subtasks;
extracting dynamic context information and a plurality of control points relevant to the task and the context information, each of the control point indicates an optimal state;
generating a primary optimal plan state complying with the task, the context information and each of the control point, the plan including a plurality of intermediate states to achieve a goal state;
determining a next plan state by a process of opinion mining, opinion mining further comprising:
aggregating one or more opinion of multiple entities located at different sources or networks along with the subtasks contained in one or more category of the user preference modeling system,
assigning an updated score to each of the aggregated opinion for prioritizing in accordance with a predetermined category score; and
selecting the highest updated scored opinion thereof wherein the said updated scored opinion is derived by a combination of the entity opinion score and the category score; and
iteratively performing a backtracking operation from the goal state to the currently executing intermediate state to identify a deviating intermediate state from the optimal state for ensuing generation of a secondary optimal plan state there from the deviated intermediate state.

15-24. (canceled)

25. The method of claim 14, wherein the updated assigned scores are normalized and weighted to frame a positive opinion or a negative opinion or a neutral opinion based on a predetermined threshold value.

26. (canceled)

27. The method of claim 14, wherein the predetermined category score is associated with a reward value, wherein the reward value is positive for the entities involved in generating successful optimal plan and negative for the entities involved in the plan steps, inclusion of which requires elimination of the intermediate states during plan revision.

28. The method of claim 14, wherein the scores are updated by combining an initial score and the reward value.

29-31. (canceled)

32. An optimal personalized plan generation system implemented on a planning server, the system comprising:
a user preference modeling system to model a user defined task and associated subtasks;
a context processing system communicating with a plurality of sensors and an ontology store management system for extracting dynamic contextual information; and
a plan execution decider system for generating a primary optimal plan in compliance to the task, the subtasks and the contextual information, wherein the decider system is configured to generate a secondary optimal plan upon an indication of deviation from the user preference modeling system or the context processing system plan or a combination thereof.

33. The system of claim 32, further comprising:
a user interface for receiving the at least one task and the associated subtasks from the one or more user;
a defining system coupled with the user preference modeling system and a context processing system for generating the task description and a domain information description with the relevant subtasks using the ontology store management system;
an opinion aggregation system implemented on a server or a cloud resource for extracting opinions of plurality of entities located at different sources or networks;
a plan rendering system for rendering the at least one optimal plan in compliance with the user defined task and the associated subtasks; and
a plan explanation generator system for generating natural language explanations to the user for selecting the optimal plan.

34. (canceled)

35. The system of claim 32, wherein the plan execution decider system further comprises:
a monitoring system for detecting the deviation from the primary optimal plan, the plan including plurality of intermediate states; and
a plan revision system to identify the intermediate state where on a plan revision condition exists.

36. (canceled)

37. (canceled)

38. The system of claim 32, wherein the ontology store management system further comprises:
a database for storing the domain specific information including the user defined tasks, dependencies among the tasks, parameters governing invoking of a task, and different constraints associated with the task execution; and
a ontology management tool for managing the stored information and a ontology extraction system.

39-45. (canceled)
